(19) United States
(12) Patent Application Publication
(10) Pub. No.: US 2015/0149198 A1
(43) Pub. Date: May 28, 2015

(54) METHOD AND APPARATUS TO SYNCHRONIZE DRUG INFORMATION

(71) Applicant: Codonics, Inc., Middleburg Heights, OH (US)

(72) Inventors: Richard Edwards, Akron, OH (US); Michael Kolberg, Hinckley, OH (US); Gary Keefe, Brecksville, OH (US)

(21) Appl. No.: 14/551,697

(22) Filed: Nov. 24, 2014

Related U.S. Application Data
(60) Provisional application No. 61/908,150, filed on Nov. 24, 2013.

(51) Int. Cl. G06F 19/00

(52) U.S. Cl. CPC G06F 19/326
USPC 705/2

(57) ABSTRACT

Devices of a networked system for transmitting communications at a healthcare institution, including drug labeling and formulary management devices, can be updated by supplementing received drug information with drug information from a similar drug already in the formulary. The received drug information is compared with other drugs already in the formulary and a match quality value is determined based on this comparison. A selection of a matching or similar drug is made based on the determined match quality value. The received drug information and drug information from the selected matching or similar drug can be combined to update the formulary with all of the desired information.

### CROSS REFERENCE TO RELATED APPLICATIONS

This application claims priority to U.S. Provisional Application Ser. No. 61/908,150, filed on Nov. 24, 2013, entitled “METHOD AND APPARATUS TO SYNCHRONIZE DRUG INFORMATION”, the entirety of which is incorporated herein by reference.

### BACKGROUND OF THE INVENTION

1. Field of the Invention

This application relates generally to transferring drug information between devices, and more specifically to reconciling drug information for compatibility between devices, and more specifically to ensuring the accuracy of reconciled drug information using external verification.

2. Description of Related Art

Conventional devices used in healthcare institutions require drug information to perform their intended functions. Examples of these devices include, EMR (Electronic Medical Record) systems that receive, store and provide medical information to users and other devices in the healthcare institution including information related to drugs, ADC (Automated Dispensing Cabinet) systems that store and control the distribution of drugs and drug related products, and drug labeling systems that print labels identifying drug preparations on syringes, IV bags or other drug delivery containers.

Devices that require drug information typically rely on a formulary, also referred to as a drug library or drug database. The formulary contains the necessary drug information for proper operation of the device that is structured in a format compatible with the device. Formularies are usually configured with data and an arrangement of data specific to each type of device, and contain information for one or more drugs. Information in the formulary can be classified into two broad categories: general drug information and device-specific drug information.

General drug information includes information necessary for a clinician to correctly identify a drug and make clinical decisions related to patient care, optionally involving the therapeutic effect and/or administration of the drug. This information commonly includes attributes such as the drug name and concentration. Other attributes of general drug information can also include, but are not limited to, the dose, volume and manufacturer identification code of the drug in the original container.

Device-specific drug information is additional information in the formulary associated with a drug that is required for proper operation of the device to perform the intended purpose of that specific device, and can optionally not be utilized by another device at the healthcare institution. Examples of device-specific information include administrative data such as drug cost and ordering information for EMR systems, drug inventory count and drawer location for ADC systems, and drug label color and warnings or precautions for the associated drugs for drug labeling systems that print labels for drug containers bearing such color and/or warnings or precautions.

The device-specific drug information for each type of device can vary greatly. This creates a challenge for healthcare institutions to keep formularies for each type of device up-to-date when drugs are added, removed or changed. A large healthcare institution can have dozens of formularies to manage.

A formulary management application is another example of a device that requires drug information. Formulary management applications are typically supplied by the manufacturer of each type of device for the specific purpose of updating drug information in the respective device's formulary. Formulary management applications allow a user to add, remove or change drug information in the formulary when drug availability changes or the intended use of a drug changes in the healthcare institution. The user must repeat the process of updating formularies for each type of device. The manual nature of updating drug information and the operational differences between various formulary management applications makes this process time-consuming and prone to errors.

### BRIEF SUMMARY OF THE INVENTION

The following summary is meant only to provide a basic overview of the present invention and is therefore not meant to be limiting in any way. In light of the above, there is presently a need to reduce the number of manual steps required to update formularies across different types of devices to save healthcare personnel valuable time and reduce errors as described herein below.

According to one example described herein, a method of updating a drug formulary comprises receiving, with a first device over a communication network, a transmission comprising received drug information to be included in an update of the drug formulary; utilizing at least a portion of the received drug information to identify a similar drug included in the drug formulary before the update; extracting information pertaining to the similar drug from the drug formulary and supplementing at least a portion of the received drug information with at least a portion of the extracted drug information; and storing, in the drug formulary, at least a portion of the extracted information in a relationship with the at least a portion of the received drug information.

In various embodiments of the above example, the method further comprises comparing the received drug information with drug information of drugs included in the drug formulary before the update in order to identify the similar drug; the compared received drug information comprises at least two of an identification code, a name, a concentration, a volume, and a dose; the method further comprises determining a drug match quality value based on the comparison of received drug information and drug information of drugs already included in the drug formulary; the drug match quality value is determined based on a weighted value of quality assessments for each attribute of received drug information compared with drug information of drugs already included in the drug formulary; the method further comprises receiving confirmation that the similar drug based on the drug match quality value corresponds to an entry in the drug formulary that is to be updated; information pertaining to the similar drug is automatically extracted and stored in a relationship with the at least a portion of the received drug information and is stored based on the drug match quality value; and/or the method further comprises transmitting the stored information to another device on the communication network.

According to another example described herein, a method of managing a drug database comprises receiving, at a first terminal, drug information to be added to or modified within the drug database; comparing the received drug information with drug information of drugs already included in the drug database; determining a drug match value indicative of how well the received drug information matches the drug information already included in the drug database based on the comparison; and adding to or modifying the drug database with at least a portion of the received drug information and at least a portion of the drug information of a matching drug, the matching drug being one of the drugs already included in the drug formulary.

In various embodiments of the above example, a device storing the drug formulary and the first device are connected to a common communication network, and communicate with each other from remote locations over the common communication network; the compared received drug information comprises at least two of an identification code, a name, a concentration, a volume, and a dose; the method further comprises outputting similar drugs to a user of said first terminal, the similar drugs being determined based on the drug match value; the method further comprises receiving confirmation that the matching drug corresponds to an entry in the drug database that is to be updated, wherein the matching drug is selected from the list of outputted similar drugs; the at least a portion of the received drug information and the at least a portion of a drug already in the drug database is automatically added to or modified within the drug database based on the drug match value; the drug match value is determined based on a weighted value of quality assessments for each attribute of received drug information compared with drug information of drugs already included in the drug database; and/or the method further comprises transmitting the stored information to another, remotely-located terminal on the common communication network.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 illustrates an embodiment of a networked system for transmitting communications between devices at a healthcare institution;

FIG. 2 illustrates an example method for updating formularies as described herein; and

FIG. 3 illustrates another example method for updating formularies as described herein.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

A method and apparatus that reduce the number of manual steps required to update formularies across different types of devices to save healthcare personnel valuable time and reduce errors are described herein below.

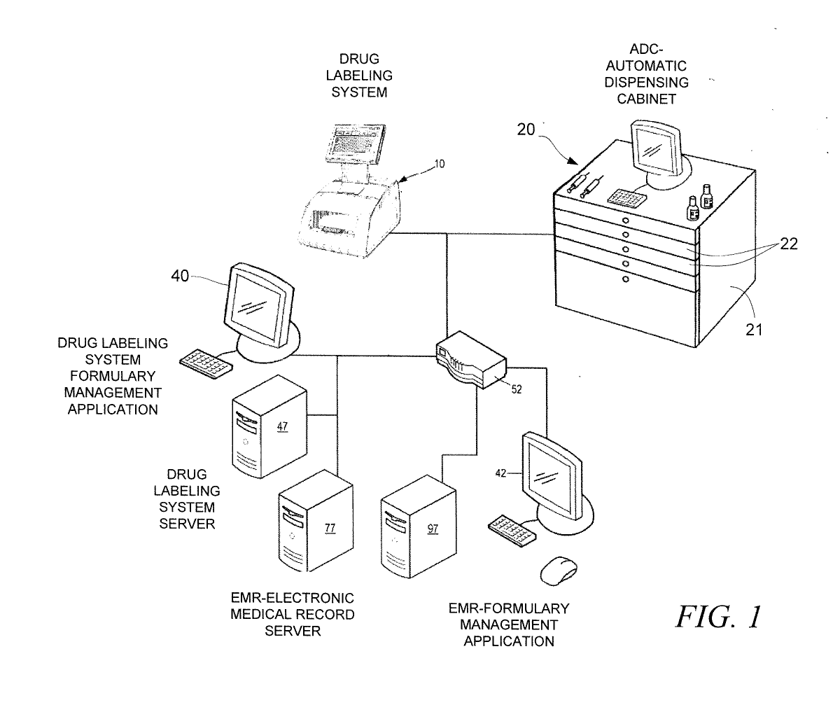

An illustrative embodiment of a networked system for transmitting communications between devices at a healthcare institution is shown schematically in FIG. 1. The communication network is schematically depicted as a router/switch 52 in FIG. 1, but can be embodied by any communication equipment and protocols such as a wide area network (“WAN”) (e.g., the Internet), a local area network (“LAN”) configured to facilitate electronic communications between devices at a single geographic location, or a combination of a WAN and a LAN. Accordingly, the healthcare institution network can be distributed across a plurality of different geographic locations, contained at a single facility, or arranged and configured in any other desired manner without departing from the scope of present disclosure.

The embodiment of the networked system shown in FIG. 1 includes a drug labeling system 10 that scans a barcode or other computer-readable code associated with a drug and prints a label that includes a computer-readable code identifying the drug to be applied to a delivery container. An example of such a drug labeling system 10 is described in U.S. application Ser. No. 13/274,184 to Edwards et al., which is incorporated in its entirety herein by reference. Generally, the drug labeling system 10 scans a barcode or other machine-readable code provided to a container storing a drug to be administered to a patient, and references the general drug information in the formulary stored in a computer memory accessible to the drug labeling system 10 to identify the drug corresponding to the read barcode. The drug labeling system 10 also references the device-specific drug information to identify a color code that is to be applied to a label produced for that drug to indicate a drug classification in which that drug falls. The color code is an example of the device-specific information included in the formulary utilized by the drug labeling system 10 because the color code is pertinent to, and used for printing a label for the drug, but is not used by the automated dispensing cabinet 20, for example, discussed below.

Also included as part of the system is an automated dispensing cabinet (“ADC”) 20. The ADC 20 includes a cabinet 21 provided with a plurality of drawers 22 that are selectively opened to grant an authorized party access to drugs therein. A suitably-programmed computer 24 provided to the ADC 20 can include a barcode or other code scanner that reads a compatible code and opens the appropriate drawer 22 where the drug corresponding to the code is stored. When a barcode or other code scanner is not used by the ADC 20, a traditional input device such as a keyboard and/or mouse connected to the computer 24 can select a drug or other drug related supply and open the appropriate drawer 22.

One or more servers 47, 77, 97 can be programmed to store and maintain an electronic medical record (“EMR”) system and optionally a different formulary specific to each of a plurality of different devices (e.g., drug labeling system 10 and ADC 20). Computer terminals 40, 42 can be programmed to execute applications for managing (e.g., creating, updating and otherwise maintaining) a formulary to be utilized by, for example, the drug labeling system 10 and the EMR, respectively. A common computer terminal 42 can optionally be programmed to manage the formulary for more than one such device, or different computer terminals can optionally be programmed specifically to manage each of the different formularies.

In one embodiment of the invention, a device (e.g., drug labeling system 10) is configured to receive drug information from another device (e.g., computer terminal 40 executing a drug labeling system formulary management application). The received drug information indicates that a new drug has been added. The device receiving the indication that a new drug has been added will search for a similar drug that already exists in the formulary of the receiving device utilizing, for example, at least two attributes from the new drug information received. A similar drug is found when an existing drug in the receiving device formulary matches, for example, at least two attributes of the received drug information, such as the same drug name and same concentration. When a similar drug match is found, the device-specific drug information of the existing drug and any relevant general drug information from the existing drug are used to supplement or complete the drug information for the received drug information being added to the receiving device formulary. The two attributes used to identify a similar drug can be manually established or can be automatically established based on the drug information received.

For example, a healthcare institution decides to purchase the drug Propofol from a new supplier. The new supplier packages Propofol in a vial with a concentration of 10 mg/mL and a volume of 20 mL. This packaging is the same as other Propofol vials used in the healthcare institution that are purchased from other suppliers. A user adds drug information related to the new Propofol drug to the EMR formulary that includes the drug name (Propofol), concentration (10 mg/mL) and volume (20 mL), utilizing the computer terminal 42 executing the EMR formulary management application. The EMR formulary management application being executed by the computer terminal 42 recognizes that a new drug called Propofol with a concentration of 10 mg/mL and a volume of 20 mL has been added and transmits a message over the communication network 52 in response. This message is received by the formulary management application being executed by the computer terminal 40 for managing a formulary of a drug labeling system 10, and/or by the drug labeling system 10 itself. The formulary management application uses the drug name (Propofol) and drug concentration (10 mg/mL) from the received drug information to search for a similar drug in the formulary from the set of existing drugs already contained in the drug labeling system formulary. The similar drug utilized by the drug labeling system 10 has the same drug name and same concentration.

When a match is found, the formulary management application extracts general drug information and device-specific drug information that can be used to supplement or complete the received drug information. Such information may include label color, alternate drug name representations, warning messages, or other available information from the matching drug information. The received drug information for Propofol is then added to the drug labeling system formulary as a new entry for that drug that also includes at least a portion of the general drug information and/or device-specific drug information extracted from the existing entry of the matching similar drug. Any general drug information and/or device-specific drug information extracted from the existing entry that conflicts with the received drug information can optionally be superseded by the received drug information. For instance, if the supplier name is extracted from the existing entry and the new supplier name is specified in the received drug information, the new supplier name can be saved in the new entry being saved.

In another embodiment of the invention, a device configured to receive drug information, receives an indication that a drug has been removed. The device receiving the indication will utilize at least a portion of the general drug information from the received drug information to find a matching drug already contained in the formulary of the receiving device. A matching drug is found when an existing drug in the formulary of the receiving device matches attributes of the received drug information that create a unique, unambiguous information set that ensures the correct drug information is identified for removal. When information for an existing drug in the receiving device's formulary matches the received drug information identifying the drug to remove, the existing drug information is removed from the formulary or identified as no longer valid for use.

For example, a drug labeling system is operatively connected to an ADC. The healthcare institution is notified that the drug Midazolam with a concentration of 2 mg/mL and a manufacturer identification code of 1234567890 is being recalled. The formulary on the ADC is updated to remove drug information for Midazolam with a concentration of 2 mg/mL and a manufacturer identification code of 1234567890. The ADC 20 transmits a message containing drug information that indicates this drug has been removed or is no longer approved for use.

This message is received by a drug labeling system 10. The drug labeling system 10 uses the manufacturer identification code of 1234567890 along with the drug name (Midazolam) and drug concentration (2 mg/mL) to search for a matching drug in the set of existing drugs already contained in the drug labeling system formulary. The combination of the manufacturer identification code with other drug information such as drug name and drug concentration can be used to ensure that a unique, unambiguous set of information is used to find the correct drug for removal in the drug label system formulary. This is because some manufacturer identification coding systems, such as the NDC (National Drug Code) used in the United States, can result in identical manufacturer identification codes on different drugs. Only by combining the NDC code with other drug information is uniqueness guaranteed. When a match is found between the received drug information and drug information in the drug label system formulary, the information for Midazolam with a concentration of 2 mg/mL and a manufacturer identification code of 1234567890 in the drug labeling system formulary is removed from the formulary or identified as no longer valid for use.

In another embodiment of the invention, a device configured to receive drug information, receives an indication that a drug has been changed. The device receiving the indication can utilize at least a portion of the general drug information from the changed drug to find a matching drug already contained in the formulary of the receiving device. A matching drug is found when an existing drug in the formulary of the receiving device matches attributes of the received drug information that create a unique, unambiguous information set that ensures the correct drug information is identified to be changed. When information for an existing drug in the receiving device's formulary matches the received drug information identifying the drug to change, the existing drug information in the formulary is overwritten with the general drug information received for the changed drug.

In another embodiment of the invention, any drug information that is added or changed in the formulary of a device as a result of receiving general drug information from another device that does not provide for unique, unambiguous identification of drug information in the formulary of the receiving device can have the drug information status set to “not verified” or the like. Drug information that is not verified requires external verification (e.g., manually-entered confirmation that the drug identified in the formulary using the added or changed drug information received from another device is the correct drug and the general drug information and/or specific drug information is correct) by a clinician or other authorized source before the drug information can be used for clinical purposes (e.g., used in the provision of healthcare to a patient). After the drug information is verified, the status associated with the drug information can be set to indicate “verified” or the like.

In another embodiment of the invention, any drug information that is added or changed in the formulary of a device as a result of receiving general drug information from another device that provides for unique, unambiguous identification of drug information in the formulary of the receiving device will have the drug information status set to “verified” or the like. Drug information that is verified can be used for clinical purposes.

While the above example embodiments describe the use of a drug name, concentration, volume, dose, manufacturer identification code, and the like as potential attributes for matching received drug information to existing similar drugs in the formulary, it is to be understood that these are merely examples of attributes and are not intended to be limiting. Moreover, when identifying matching drugs, it is not necessary that the received drug information be identical to drug information already in the formulary. Rather, attribute-specific match rules can be utilized to determine whether individual attributes are considered a match. In other words, attribute-specific match rules can be used to assign a corresponding attribute-specific quality assessment that is indicative of the similarity between drug attributes being compared. For example, an exact name match may correspond to a 100% quality assessment of the name; while comparing a received generic drug name to a brand drug name already in the formulary may only result in an 80% quality assessment. Similarly, various degrees of spelling differences may result in varying quality assessments. Numerical values such as concentration, dose, and volume may be given a 100% quality assessment for exact matches, while values of similar drugs already stored in the formulary that are within a predetermined tolerance may correspond with lesser quality assessments. Quality assessment may also be determined based on the format of the attribute. For example, if received drug information indicates a dose of 200 mg and a volume of 20 mL, and a similar drug in the formulary has a concentration of 10 mg/mL and a volume of 20 mL, a quality assessment of 75% may be assigned indicating that the received concentration is an equivalent, but not exact match, of the similar drug.

Additionally, some drug units can be represented in scales of measurement that can be converted to other equivalent measurements. Rules for determining the quality of a match can use these properties of unit equivalence to improve the assessment of match results. For example, a drug with a concentration of 100 μg/mL (100 micrograms per milliliter) is equivalent to 0.1 mg/mL (0.1 milligrams per milliliter). By determining the numeric value and scale of measurement of an attribute such as concentration, the numeric equivalent in a different scale of measurement can be calculated allowing a higher match quality assessment such as 70% to be assigned as opposed to a low quality assessment of 0% when the numeric value in a different scale is not taken into account.

Preferably, better matches result in higher quality assessments. The attribute-specific quality assessments, taken individually or in combination, can be used to determine the overall drug match quality between received drug information and each drug in the set of existing drug information in the formulary of the device. For example, an overall drug match quality may be determined by equally weighting the quality assessment for each attribute (for example, averaging the quality assessment values) or different attributes may be assigned different weights. The drug match quality for each similar drug resulting from the search of the existing drug information in the formulary on the device can be sorted based on the drug match quality. In doing so, similar drugs with a match quality that falls below a user-assigned acceptable drug quality setting can be discarded.

A list of similar drugs with a match quality equal to or greater than the user-assigned acceptable setting can be provided to a user. For example, a user can set a predetermined drug match quality threshold of 60%. In this case, only potential drug matches with an overall match quality of 60% or better will be displayed to the user to confirm a match. In another example, a user may set a threshold of 95% or 100% such that only nearly perfect, or perfect, matches are provided and any potential drug matches with a lower quality match quality is ignored. In this case, it is less likely that a match will be found and more likely that the new or modified drug information will have to be input manually. The user may then confirm which, if any, of the similar drugs listed is a match. Once a match is verified, at least a portion of the received drug information and a portion of the matching drug information can be used to update the formulary. In other embodiments, the formulary may be updated with such information automatically if, for example, only one match is returned or if a match has a 100% match quality value.

The new or modified drug information may also be broadcast to other devices in the network, for example, ADC 22, and/or servers and terminals running drug labeling system formulary management applications or EMR formulary management applications, and the like. In such embodiments, the formularies for these devices may be automatically updated or request verification from a user of the device. Similarly, a drug labeling system could receive similar updates from the other devices on the network.

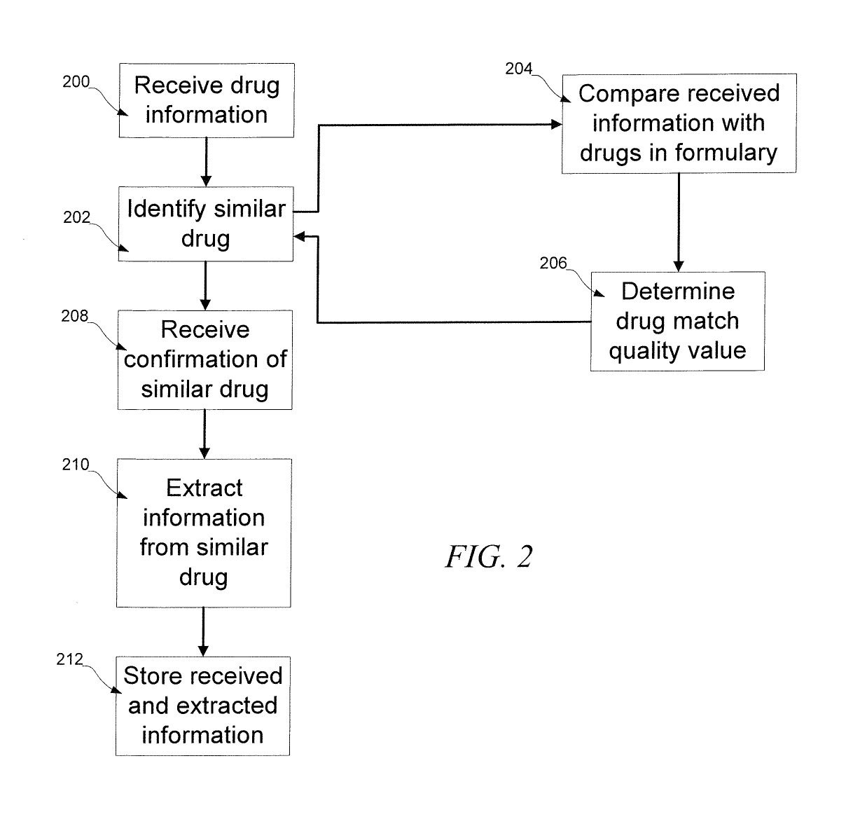

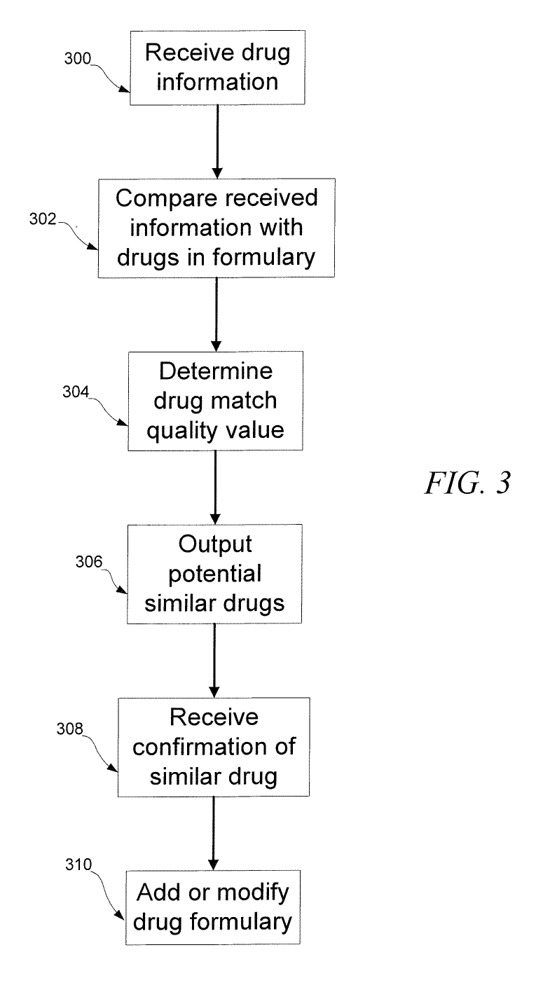

FIGS. 2 and 3 illustrate example methods for updating a formulary in light of the above disclosure. In one embodiment, shown in FIG. 2, drug information is first received 200 with a first device on a communication network. Next, at least a portion of the received drug information is utilized to identify 202 a similar drug included in the formulary before the update. To identify a similar drug, the received drug information may be compared 204 with drug information of drugs included in the formulary before the update. Once the information is compared, a drug match quality value can be determined 206 based on the comparison of received drug information and drugs included in the formulary and then a similar drug may be confirmed based on the drug match quality value 208. Once the similar drug is identified 202, information pertaining to the similar drug can be extracted 210 from the formulary and used to supplement the received drug information. Finally, the information extracted from the formulary in a relationship is stored 212 with at least a portion of the received drug information.

According to the embodiment illustrated in FIG. 3, a device receives drug information 300 for a drug to be added to or modified within the drug formulary. Next, the received drug information can be compared 302 with drug information of drugs already included in the formulary. Based on this comparison, a drug match quality value can be determined 304 and potential similar drugs can be output 306 to a user of the device. The user of the device may then confirm 308 a matching drug and at least a portion of the received drug information and the matching drug information can be added to or modified 310 within the formulary.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of updating a drug formulary, the method comprising:
receiving, with a first device over a communication network, a transmission comprising received drug information to be included in an update of the drug formulary;
utilizing at least a portion of the received drug information to identify a similar drug included in the drug formulary before the update;
extracting information pertaining to the similar drug from the drug formulary and supplementing at least a portion of the received drug information with at least a portion of the extracted drug information; and
storing, in the drug formulary, at least a portion of the extracted information in a relationship with the at least a portion of the received drug information.

2. The method of claim 1, further comprising comparing the received drug information with drug information of drugs included in the drug formulary before the update in order to identify the similar drug.

3. The method of claim 2, wherein the compared received drug information comprises at least two of an identification code, a name, a concentration, a volume, and a dose.

4. The method of claim 2, further comprising determining a drug match quality value based on the comparison of received drug information and drug information of drugs already included in the drug formulary.

5. The method of claim 4, wherein the drug match quality value is determined based on a weighted value of quality assessments for each attribute of received drug information compared with drug information of drugs already included in the drug formulary.

6. The method of claim 4, further comprising receiving confirmation that the similar drug based on the drug match quality value corresponds to an entry in the drug formulary that is to be updated.

7. The method of claim 4, wherein information pertaining to the similar drug is automatically extracted and stored in a relationship with the at least a portion of the received drug information and is stored based on the drug match quality value.

8. The method of claim 1, further comprising transmitting the stored information to another device on the communication network.

9. A method of managing a drug database, the method comprising:
receiving, at a first terminal, drug information to be added to or modified within the drug database;
comparing the received drug information with drug information of drugs already included in the drug database;
determining a drug match value indicative of how well the received drug information matches the drug information already included in the drug database based on the comparison; and
adding to or modifying the drug database with at least a portion of the received drug information and at least a portion of the drug information of a matching drug, the matching drug being one of the drugs already included in the drug formulary.

10. The method of claim 9, wherein a device storing the drug formulary and the first device are connected to a common communication network, and communicate with each other from remote locations over the common communication network.

11. The method of claim 9, wherein the compared received drug information comprises at least two of an identification code, a name, a concentration, a volume, and a dose.

12. The method of claim 9, further comprising outputting similar drugs to a user of said first terminal, the similar drugs being determined based on the drug match value.

13. The method of claim 12, further comprising receiving confirmation that the matching drug corresponds to an entry in the drug database that is to be updated, wherein the matching drug is selected from the list of outputted similar drugs.

14. The method of claim 9, wherein the at least a portion of the received drug information and the at least a portion of a drug already in the drug database is automatically added to or modified within the drug database based on the drug match value.

15. The method of claim 9, wherein the drug match value is determined based on a weighted value of quality assessments for each attribute of received drug information compared with drug information of drugs already included in the drug database.

16. The method of claim 9, further comprising transmitting the stored information to another, remotely-located terminal on the common communication network.
